(19) United States
(12) Patent Application Publication
(10) Pub. No.: US 2005/0184973 A1
(43) Pub. Date: Aug. 25, 2005

(54) Apparatus providing multi-mode digital input

(75) Inventors: Dwayne E.M. Lum, Austin, TX (US); Douglas L. Fowler, Frisco, TX (US); James E. Gibbons JR., Austin, TX (US); Yu-Cheng Hua, Taipei (TW); Chan-Mei Chu, Taipei (TW); Philip R. Bagwell, Georgetown, TX (US)

Correspondence Address: David Allen Hall;Jackson Walker L.L.P., Suite 2100, 112 E. Pecan Street, San Antonio, TX, 78205-1521, US

(73) Assignee: XPLORE TECHNOLOGIES CORPORATION

(21) Appl. No.: 11/065,903

(22) Filed: Feb. 25, 2005

Related U.S. Application Data
(60) Provisional application No. 60/547,530, filed on Feb. 25, 2004.

(51) Int. Cl. G09G 5/00

(52) U.S. Cl. 345/173

(57) ABSTRACT

An apparatus that provides multi-mode digital input to computers, tablets, personal digital assistants, global positioning satellite systems, and other such devices. Digital information can be transferred via passive inputs such as resistive or capacitive touch using a human finger or a stylus, via passive acoustic surface wave or electro-optical devices, via active technology such as inductive and RF inputs, and via active wired inputs such as a mouse or a touch pad. The preferred input mode can be selected by an operator, or simultaneous input modes can be sensed, differentiated, and prioritized by the apparatus.

This patent claims priority from and incorporates by reference U.S. Patent Application Ser. No. 60/547,530, filed Feb. 25, 2004.

### FIELD OF THE INVENTION

The present invention pertains to the field of digital devices, more particularly to the field of devices providing digital input to computers, tablets, touch panels, personal digital assistants (PDA), global positioning satellite (GPS) systems, laboratory and clinical instruments, numerically-controlled (NC) manufacturing systems, and other such electronic apparatus. Herein, a GPS device is one of the category of commonly understood instruments that use satellites to determine the substantially precise global position of an object. A PDA is one of the category of commonly understood pocket or purse devices used for data storage and manipulation, calendaring, Internet access, and other personal and office tasks.

### BACKGROUND OF THE INVENTION

The ubiquitous computer mouse generally operates in relative mode, i.e., the sensing of the movement of a mouse component such as a roller ball between two points on a two-dimensional grid. A mouse raised above a first location on its grid, moved, and set on its grid in a second location will not register the full extent of its movement. It will only register the small movement associated with jarring of the roller ball or other sensing device caused by the unsteadiness of the operator raising and lowering the mouse.

A mouse is a satisfactory means of input where choices are made and commands are given through the use of menu selections, but a mouse operating in the relative mode is unacceptable for input to devices requiring indication of absolute position or displacement from a datum. Devices have been developed for satisfaction of the latter requirements, that is, devices that operate in the absolute mode. Such a device, sometimes called a curser device, if raised above a first location on its grid, moved, and set on its grid in a second location, will register its absolute position and the full extent of its movement. Such devices include acoustic surface wave, electro-optical, electro-magnetic (inductive), radio frequency (RF), and wireless devices. Resistive or capacitive devices manipulated with a stylus or a human digit also generally operate in the absolute mode.

Input devices for digital systems can be categorized in two broad categories: active and passive. Passive devices include those that are receptive in a predictable manner to resistive, capacitive, acoustic surface wave, or electro-optical variations due to contact or touch by, for instance, a human finger or a stylus. Active devices include inductive and RF devices. Wired inputs such as a mouse or a touch pad are a subset of the active devices category.

The mouse and resistive touch and inductive digitizing devices are well known in the field relevant to the present invention. See for instance Asami (U.S. Pat. No. 6,700,515 B2), Ahn (U.S. Pat. No. 6,670,949 B1), Chao (U.S. Pat. No. 6,180,894 B1), and Schmenk (U.S. Pat. No. 5,701,141). Chao also discloses dual-mode digital input. However, none of the prior art discloses all the features of the present invention.

### SUMMARY OF THE INVENTION

The present invention is capable of receiving, digitizing, recognizing, prioritizing, buffering, storing, and selectively utilizing multi-mode digital data in the form of passive, active, and wired inputs. The present invention, conforming to a predetermined priority scheme, alternates between or among the apparatus inputs

### BRIEF DESCRIPTION OF THE DRAWINGS

FIG. 1 is a diagram of the preferred embodiment of the present invention.

FIG. 2 is a block diagram showing the multi-mode architecture of the preferred embodiment.

FIG. 3 is a flow diagram of the auto-sense function of the preferred embodiment.

### DETAILED DESCRIPTION OF THE PREFERRED EMBODIMENT

The structure and operation of the invention will become apparent upon reading the following detailed description of the preferred embodiment and upon reference to the accompanying drawings in which like details are labeled with like identification numbers throughout.

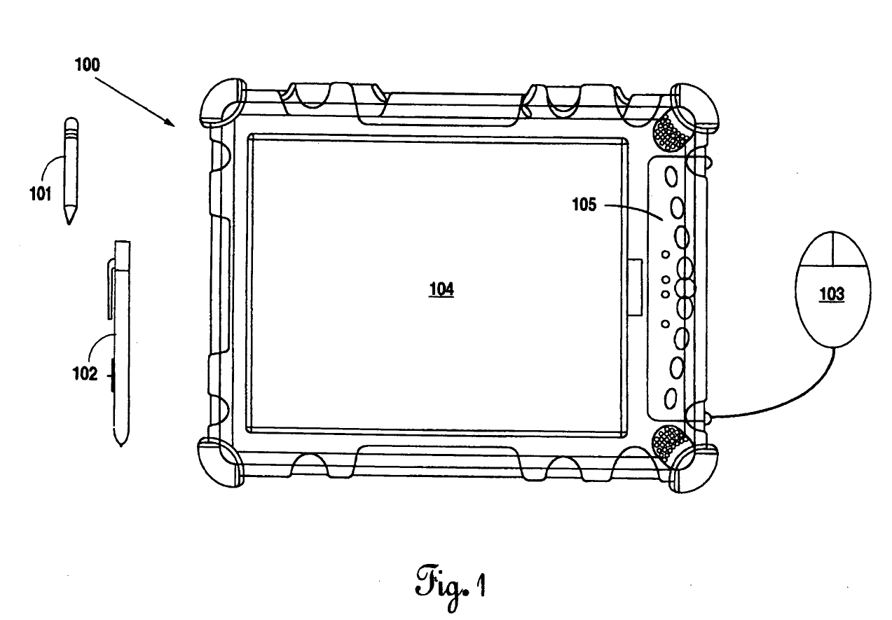

On Oct. 4, 2004, the Assignee of this application, Xplore Technologies® Corporation of America, announced the preferred embodiment of the present invention in the form of the auto-sensing multi-mode capability of its iX104C²™ rugged tablet personal computer 100 illustrated in FIG. 1. Multi-mode tablet PC 100 features a passive input stylus 101, a wireless input pen 102, and an active wired mouse 103. Commonly understood resistive overlay touch panel 104 senses impingement by input stylus 101 or a human finger, and commonly understood sensors integral to PC 100 sense proximity of the wireless pen 102. An operator may use pen 102, wired mouse 103, and a finger or stylus 101 impinging touch panel 104 separately or simultaneously, in which case auto sense software resident in the memory of tablet PC 100 senses the three different inputs and prioritizes them according to a predetermined order. PC 100 also includes an integral keypad 105 with programmable function keys that provide manual control of the input devices and the auto sense function.

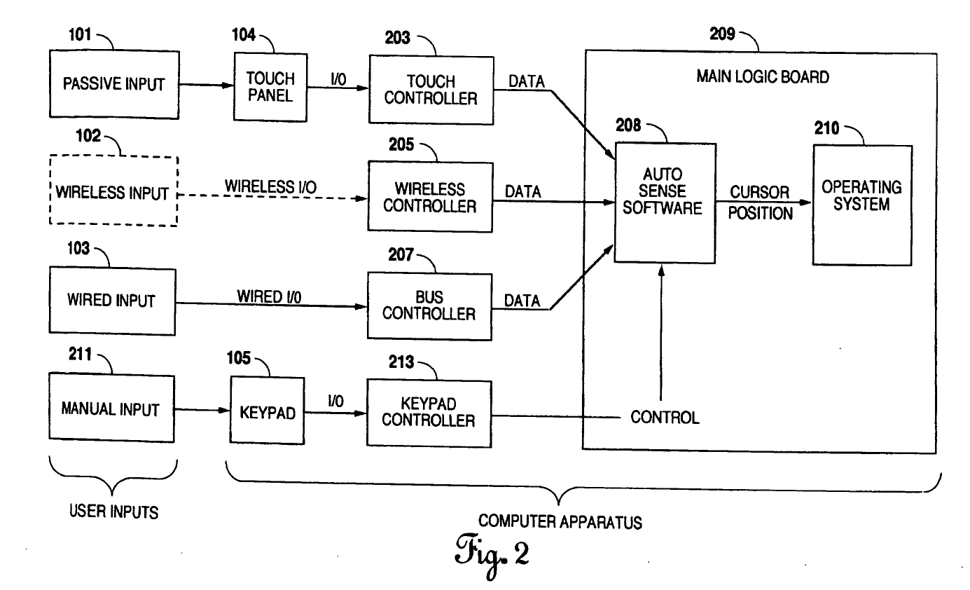

FIG. 2 shows the overall multi-mode architecture of the present invention. Three distinct input methods are illustrated. The operator may enter input by pressing a finger or stylus 101 against a particular location on the resistive touch panel 104. Touch controller 203 measures the change in resistance of touch panel 104, resolves the touched position to X and Y grid coordinates with analog to digital conversion, and sends the absolute position to the auto sense software 208 on the main logic board 209. The auto sense software 208 then processes the input data and sends cursor control data to the operating system 210.

The operator may also enter input by placing an active wireless inductive pen 102 proximate to wireless controller or digitizer 205 that electromagnetically detects the presence of pen 102, determines the center or point of origin based on electromagnetic field strength or footprint, and sends this absolute position to the auto sense software 208. The operator may also use a wired device such as a mouse 103 to input absolute or relative position data to bus controller 207. The auto sense software 208 will place data from the three sources in a time based queue according to their order of receipt and a predetermined priority. The operator may enable or disable the auto sense function by manual input 211 to the keypad 105. The command is then sent to the keypad controller 213 that then controls the state of the auto sense software 208.

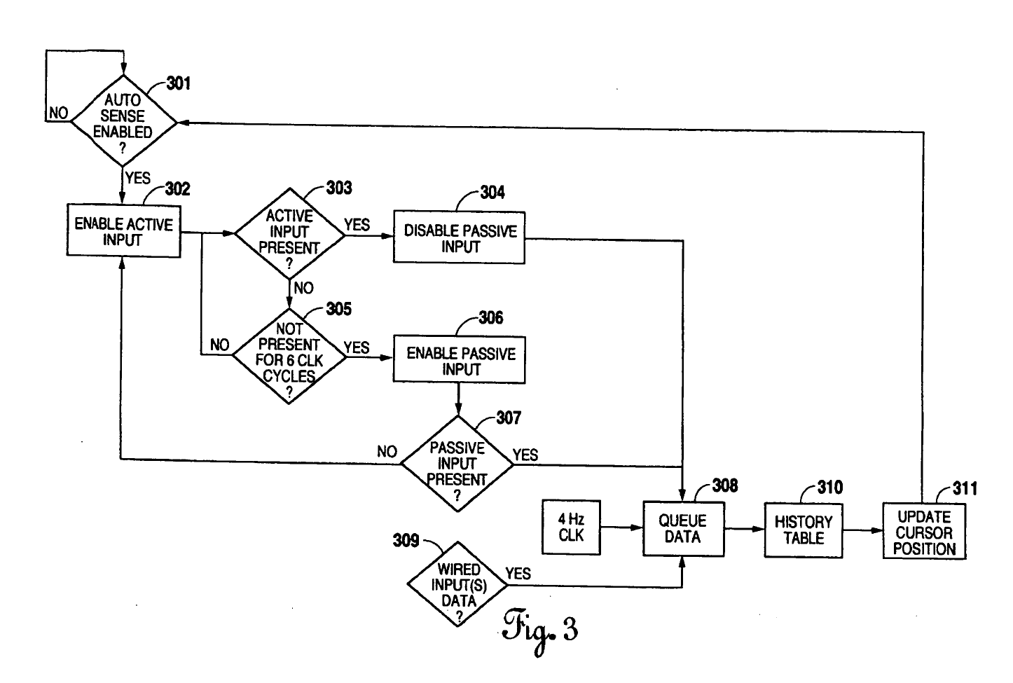

FIG. 3 illustrates the auto sense function of the present invention. The auto sense function is enabled (301) automatically as a default software setting or manually by the user by pressing a programmable function key on the computer keypad 105. The auto sense function may only be enabled if both active and passive input devices are present. Once enabled (302), the auto sense function first enables data input from the active device, then determines if an active pointing device such as pen 102 is present (303). If present, the input from the passive device will be disabled or turned off (304). If input from an active device is not present for over approximately 1.5 seconds (305), then the passive device will be turned on and its input enabled (306). If a passive input is detected (307), its position data will be placed in a time synchronized queue 308. If a passive input device is not present, the auto sense function will continue toggling between the active and passive input devices until the presence of one or the other is detected.

Data from either the passive or active inputs are placed in a queue 308 along with inputs received from any wired devices (309) such as a mouse 103 if one or more is connected. These data are then used to form a history table 310 that is used to control the cursor position 311 on the computer display.

The auto sense function detects which input devices are present, controls which input devices are enabled, and determines which input to record and use for the cursor position. When passive, active, and wired inputs are simultaneously present, the auto sense software of the preferred embodiment will assign descending priority to the active and passive inputs, automatically switching among the different inputs according to the predetermined priority, and queuing the data in a history table in alternating fashion with the wired inputs.

It will be apparent to those with ordinary skill in the relevant art having the benefit of this disclosure that the present invention provides an apparatus for receiving, digitizing, recognizing, prioritizing, buffering, storing, and selectively utilizing multi-mode digital data in the form of passive, active, and wired inputs. It is understood that the forms of the invention shown and described in the detailed description and the drawings are to be taken merely as presently preferred examples and that the invention is limited only by the language of the claims. The drawings and detailed description presented herein are not intended to limit the invention to the particular embodiment disclosed. For example, the multi-mode digital input capabilities disclosed and claimed herein could be utilized in GPS and PDA devices, and in NC equipment, as readily as in the PC tablet of the preferred embodiment. While the present invention has been described in terms of one preferred embodiment, it will be apparent to those skilled in the art that form and detail modifications can be made to that embodiment without departing from the spirit or scope of the invention.

1. An apparatus capable of digitizing data received from a passive device and an active device, said apparatus being further capable of sensing, and discriminating between, temporally proximate data points from said passive device and said active device.

2. An apparatus as in claim 1 being further capable of digitizing data received from a wired device, said apparatus being further capable of sensing, and discriminating among, temporally proximate data points from said passive device, said active device, and said wired device.

3. An apparatus as in claim 1 being further capable of prioritizing said data points from said passive device and said active device according to a predetermined order.

4. An apparatus as in claim 2 being further capable of prioritizing said data points from said passive device, said active device, and said wired device according to a predetermined order.

5. An apparatus as in claim 1 being further capable of receiving in alternating order said temporally proximate data points received from said passive device and said active device.

6. An apparatus as in claim 2 being further capable of receiving in sequentially alternating order said temporally proximate data points from said passive device, said active device, and said wired device.

7. An apparatus as in claim 1 wherein an operator of said apparatus is capable of selecting whether said passive device or said active device, or both, will be recognized as input by said apparatus.

8. An apparatus as in claim 5 being further capable of recording in a chronological queue in said alternating order said temporally proximate data points received from said passive device and said active device.

9. An apparatus as in claim 6 being further capable of recording in a chronological queue in said alternating order said temporally proximate data points received from said passive device, said active device, and said wired device.

10. An apparatus capable of digitizing data received from a passive device and an active device; said apparatus being further capable of sensing, and discriminating between, temporally proximate data points from said passive device and said active device; said apparatus being further capable of prioritizing said data points from said passive device and said active device according to a predetermined order; said apparatus being further capable of receiving in alternating order said temporally proximate data points received from said passive device and said active device; and said apparatus being further capable of recording in a chronological queue in said alternating order said temporally proximate data points received from said passive device and said active device.

11. An apparatus capable of digitizing data received from a passive device, an active device, and a wired device, said apparatus being further capable of sensing, and discriminating among, temporally proximate data points from said passive device, said active device, and said wired device; said apparatus being further capable of prioritizing said data points from said passive device, said active device, and said wired device according to a predetermined order; said apparatus being further capable of receiving in sequentially alternating order said temporally proximate data points from said passive device, said active device, and said wired device; and said apparatus being further capable of recording in a chronological queue in said alternating order said temporally proximate data points received from said passive device, said active device, and said wired device.
